(19) United States
(12) Patent Application Publication
(10) Pub. No.: US 2026/0302839 A1
(43) Pub. Date: Oct. 1, 2026

(54) INDICATION OF CRITICALITY OF ENERGY HARVESTING TAG (ETAG) TRANSMISSIONS

(71) Applicant: QUALCOMM Incorporated, San Diego, CA (US)

(72) Inventors: Varun Amar REDDY, San Diego, CA (US); Amit GOEL, San Diego, CA (US); Sony AKKARAKARAN, Poway, CA (US)

(21) Appl. No.: 19/571,430

(22) Filed: Mar. 18, 2026

Related U.S. Application Data
(60) Provisional application No. 63/777,885, filed on Mar. 26, 2025.

(51) Int. Cl. H02J 50/80; H02J 50/00; H04W 72/566

(52) U.S. Cl. CPC H02J 50/80; H02J 50/001; H04W 72/569

(57) ABSTRACT

In some aspects, a method of wireless communication performed by a wireless relay node includes receiving, from a first energy harvesting tag, a first data packet comprising a header and a payload, wherein one or more flag bits in the header of the first data packet indicate a level of a criticality of the payload of the first data packet; and transmitting an indication that the payload of the first data packet includes critical information based on the level of the criticality of the payload of the first data packet satisfying a criticality threshold.

### CROSS-REFERENCE TO RELATED APPLICATIONS

The present Application for Patent claims the benefit of U.S. Provisional Application No. 63/777,885, entitled “INDICATION OF CRITICALITY OF ENERGY HARVESTING TAG (ETAG) TRANSMISSIONS,” filed Mar. 26, 2025, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### 2. Description of the Related Art

Electronic shelf labels (ESLs) are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by an energy harvesting tag includes receiving an energizing signal; and transmitting, based on energy harvested from the energizing signal, a data packet comprising a header and a payload, wherein one or more flag bits in the header indicate a level of a criticality of the payload of the data packet.

In an aspect, a method of wireless communication performed by a wireless relay node includes receiving, from a first energy harvesting tag, a first data packet comprising a header and a payload, wherein one or more flag bits in the header of the first data packet indicate a level of a criticality of the payload of the first data packet; and transmitting an indication that the payload of the first data packet includes critical information based on the level of the criticality of the payload of the first data packet satisfying a criticality threshold.

In an aspect, a method of communication performed by a server includes transmitting, to one or more wireless relay nodes, first scheduling information indicating a first set of time slots allocated for transmission of alert packets by any wireless relay node; receiving, from a wireless relay node of the one or more wireless relay nodes, over at least one time slot of the first set of time slots, an alert packet indicating that a payload of a data packet transmitted by an energy harvesting tag includes critical information; and transmitting, to the one or more wireless relay nodes, second scheduling information indicating a second set of time slots allocated for transmission of alert packets by any wireless relay node, wherein the second set of time slots includes more time slots than the first set of time slots.

In an aspect, an energy harvesting tag includes one or more memories; one or more antennas; and one or more processors communicatively coupled to the one or more memories and the one or more transceivers, the one or more processors, either alone or in combination, configured to: receive, via the one or more antennas, an energizing signal; and transmit, via the one or more antennas, based on energy harvested from the energizing signal, a data packet comprising a header and a payload, wherein one or more flag bits in the header indicate a level of a criticality of the payload of the data packet.

In an aspect, a wireless relay node includes one or more memories; one or more transceivers; and one or more processors communicatively coupled to the one or more memories and the one or more transceivers, the one or more processors, either alone or in combination, configured to: receive, via the one or more transceivers, from a first energy harvesting tag, a first data packet comprising a header and a payload, wherein one or more flag bits in the header of the first data packet indicate a level of a criticality of the payload of the first data packet; and transmit, via the one or more transceivers, an indication that the payload of the first data packet includes critical information based on the level of the criticality of the payload of the first data packet satisfying a criticality threshold.

In an aspect, a server includes one or more memories; one or more transceivers; and one or more processors communicatively coupled to the one or more memories and the one or more transceivers, the one or more processors, either alone or in combination, configured to: transmit, via the one or more transceivers, to one or more wireless relay nodes, first scheduling information indicating a first set of time slots allocated for transmission of alert packets by any wireless relay node; receive, via the one or more transceivers, from a wireless relay node of the one or more wireless relay nodes, over at least one time slot of the first set of time slots, an alert packet indicating that a payload of a data packet transmitted by an energy harvesting tag includes critical information; and transmit, via the one or more transceivers, to the one or more wireless relay nodes, second scheduling information indicating a second set of time slots allocated for transmission of alert packets by any wireless relay node, wherein the second set of time slots includes more time slots than the first set of time slots.

In an aspect, an energy harvesting tag includes means for receiving an energizing signal; and means for transmitting, based on energy harvested from the energizing signal, a data packet comprising a header and a payload, wherein one or more flag bits in the header indicate a level of a criticality of the payload of the data packet.

In an aspect, a wireless relay node includes means for receiving, from a first energy harvesting tag, a first data packet comprising a header and a payload, wherein one or more flag bits in the header of the first data packet indicate a level of a criticality of the payload of the first data packet; and means for transmitting an indication that the payload of the first data packet includes critical information based on the level of the criticality of the payload of the first data packet satisfying a criticality threshold.

In an aspect, a server includes means for transmitting, to one or more wireless relay nodes, first scheduling information indicating a first set of time slots allocated for transmission of alert packets by any wireless relay node; means for receiving, from a wireless relay node of the one or more wireless relay nodes, over at least one time slot of the first set of time slots, an alert packet indicating that a payload of a data packet transmitted by an energy harvesting tag includes critical information; and means for transmitting, to the one or more wireless relay nodes, second scheduling information indicating a second set of time slots allocated for transmission of alert packets by any wireless relay node, wherein the second set of time slots includes more time slots than the first set of time slots.

In an aspect, a non-transitory computer-readable medium stores computer-executable instructions that, when executed by an energy harvesting tag, cause the energy harvesting tag to: receive an energizing signal; and transmit, based on energy harvested from the energizing signal, a data packet comprising a header and a payload, wherein one or more flag bits in the header indicate a level of a criticality of the payload of the data packet.

In an aspect, a non-transitory computer-readable medium stores computer-executable instructions that, when executed by a wireless relay node, cause the wireless relay node to: receive, from a first energy harvesting tag, a first data packet comprising a header and a payload, wherein one or more flag bits in the header of the first data packet indicate a level of a criticality of the payload of the first data packet; and transmit an indication that the payload of the first data packet includes critical information based on the level of the criticality of the payload of the first data packet satisfying a criticality threshold.

In an aspect, a non-transitory computer-readable medium stores computer-executable instructions that, when executed by a server, cause the server to: transmit, to one or more wireless relay nodes, first scheduling information indicating a first set of time slots allocated for transmission of alert packets by any wireless relay node; receive, from a wireless relay node of the one or more wireless relay nodes, over at least one time slot of the first set of time slots, an alert packet indicating that a payload of a data packet transmitted by an energy harvesting tag includes critical information; and transmit, to the one or more wireless relay nodes, second scheduling information indicating a second set of time slots allocated for transmission of alert packets by any wireless relay node, wherein the second set of time slots includes more time slots than the first set of time slots.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic shelf label (ESL) system, according to aspects of the disclosure.

FIG. 2 illustrates example components of an example ESL, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example electronic shelf label (ESL) deployment scenario, according to aspects of the disclosure.

FIG. 5 is a diagram illustrating an example positioning scenario using a weighted centroid algorithm, according to aspects of the disclosure.

FIG. 6 illustrates an example energy harvesting tag (eTag), according to aspects of the disclosure.

FIG. 7 illustrates an example BLUETOOTH® Low Energy (BLE) generic attribute profile (GATT) procedure, according to aspects of the disclosure.

FIG. 8 illustrates an example ESL periodic advertising with responses (PAWR) scheme, according to aspects of the disclosure.

FIG. 9 is a diagram illustrating an example scenario for indicating the criticality of eTag transmissions, according to aspects of the disclosure.

FIG. 10 illustrates an example data packet that may be used by an eTag for uplink transmissions, according to aspects of the disclosure.

FIG. 11 is a diagram illustrating an example portion of a subframe in which a dedicated set of slots is allocated for the transmission of alert packets, according to aspects of the disclosure.

FIG. 12 illustrates an example method of wireless communication, according to aspects of the disclosure.

FIG. 13 illustrates an example method of wireless communication, according to aspects of the disclosure.

FIG. 14 illustrates an example method of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to energy harvesting tag (eTag) deployments. Some aspects more specifically relate to indicating the criticality of eTag transmissions to enable a real-time alert system. In some examples, the disclosure introduces a low-latency framework for eTag packet transmissions that integrates quality of service (QoS) information as flag bits within eTag packets. This may include modifying routing paths through electronic shelf label (ESL) radios or user equipments (UEs), adjusting energizer control information, and/or ESL radio duty cycles to ensure quick delivery.

Particular aspects of the subject matter described in this disclosure can be implemented to realize one or more of the following potential advantages. In some examples, by integrating QoS information as flag bits within eTag packets, the described techniques can be used to allow for the rapid identification and routing of critical data to the server, thereby enhancing real-time alert systems for emergencies such as fires or sudden temperature changes.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof.

Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic label displays (or electronic display devices), such as electronic shelf labels (ESLs), are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image, thereby significantly reducing power consumption.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

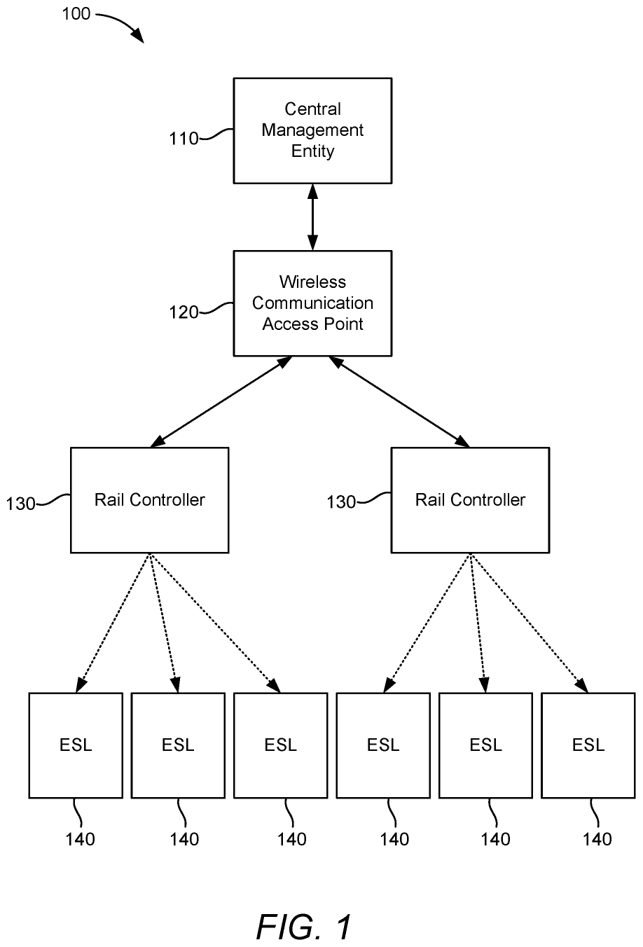

FIG. 1 illustrates an example ESL system 100, according to aspects of the disclosure. An ESL system generally includes three components: label management software (e.g., running on a central management entity 110, such as a local server at the retail location or a cloud-based server), one or more wireless communication access points 120 (e.g., Wi-Fi® access points), one or more rail controllers 130, and one or more (usually many) ESLs 140. The label management software is responsible for the configuration of the system, configuration of the properties of the ESLs 140 themselves, and storing the database of information to be displayed by the ESLs 140. The software mainly covers the network management, file systems, and transmission of data. It also processes and packs the data to be displayed into packets of information. The data packets are then sent to one or more wireless communication access points 120 via a wireless network (e.g., Wi-Fi®) for distribution to the ESLs 140 via the one or more rail controllers 130.

A wireless communication access point 120 is responsible for the stability and reliability of transmissions from the label management software (on the central management entity 110) to the ESLs 140. There may be multiple wireless communication access points 120 deployed in a single retail location based on the size of the space and/or the number of ESLs 140 deployed.

A wireless communication access point 120 communicates with one or more rail controllers 130 via a short-range wireless communications protocol, such as BLUETOOTH® Low Energy (BLE). A rail controller 130 may therefore include a BLE radio (or other short-range wireless communications protocol radio). A rail controller 130 may be powered by a battery (e.g., a lithium-ion battery) or a wired connection. A rail controller 130 is coupled to, or integrated into, a rail to which multiple ESLs 140 can be “clipped” or otherwise attached. Once clipped to the rail, each ESL 140 has a wired connection to the rail controller 130 (e.g., via a three-wire bus for power, ground, and data).

An ESL 140 functions as a receiver from the wireless communication access point 120 (via the rail controller 130) to display the information configured from the label management software. The ESL 140 then acts based on the instructions that were provided in the data packets from the label management software. An ESL 140 includes a display and optionally a camera. ESLs 140 generally do not include batteries, as they are typically powered by the rail to which they are attached. However, in some cases, an ESL 140 may be powered by a coin-cell battery, which may provide an operational life of eight to nine years. In some cases, an ESL 140 may not have a short-range wireless communications radio (e.g., a BLE radio), as it receives data from the wireless communication access point 120 via the wired rail connection to the rail controller 130.

An ESL application programming interface (API) is included in the current BLUETOOTH® specification and permits a 7-bit group identifier of 8-bit unique ESL identifiers, allowing for a total of 32,640 ESLs 140 to be allocated for one wireless communication access point 120. With those constraints, multiple wireless communication access points 120 may be needed to cover a typical grocery store ESL application.

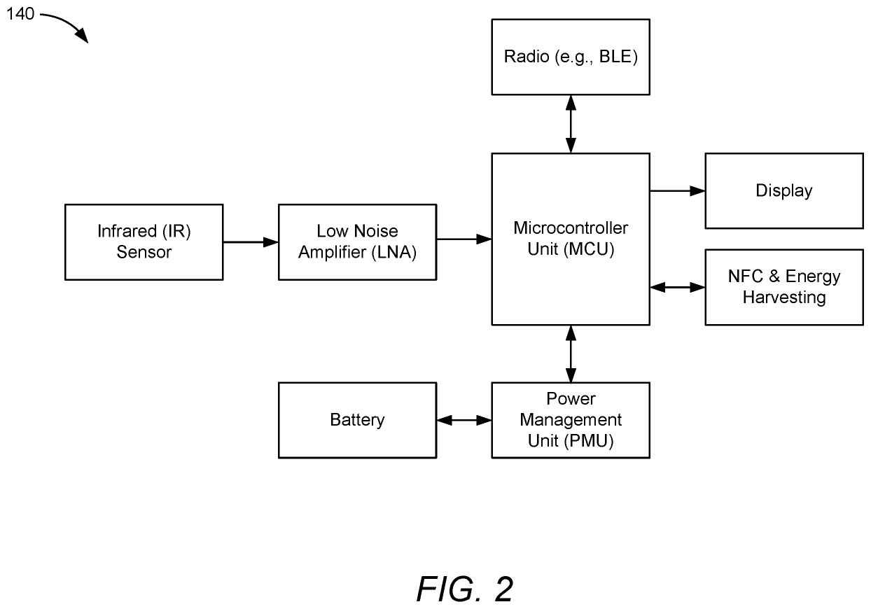

FIG. 2 illustrates example components of an example ESL 140, according to aspects of the disclosure. Note that in some cases, rather than an ESL 140 having its own wireless radio (e.g., a BLE radio) as shown in FIG. 2, multiple ESLs 140 may be attached (e.g., clipped) to a rail attached to a retail shelf. In this case, the rail (specifically a rail controller 130) contains the short-range wireless communications radio and the ESLs 140 have just the display. The rail controller 130 in the rail communicates locally to the clipped-on ESLs 140 over a wired protocol (the act of clipping on connects the ESLs 140 to the wires of the rail controller 130). As such, an ESL 140 itself may not have a radio but may connect locally to one (i.e., the rail controller 130).

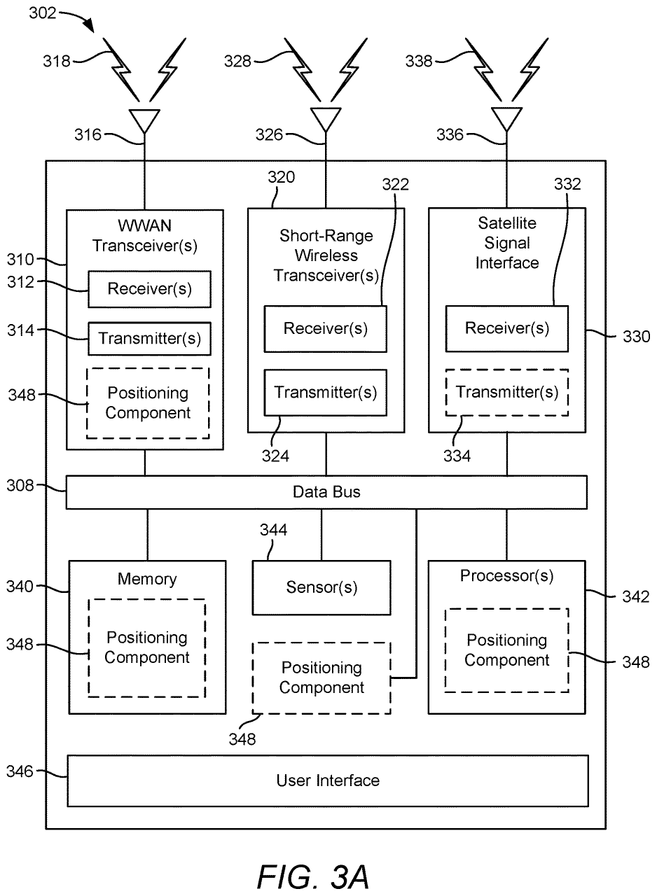

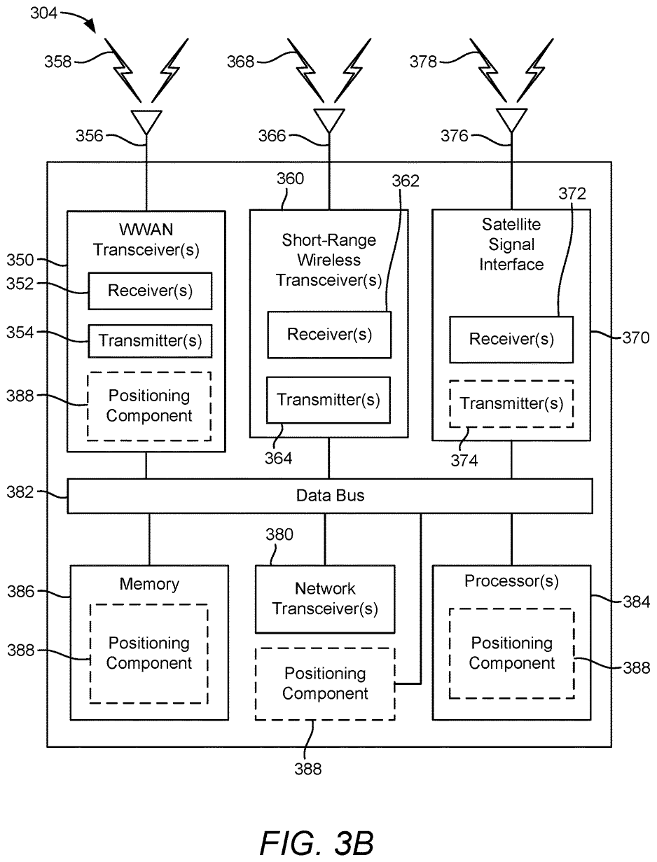

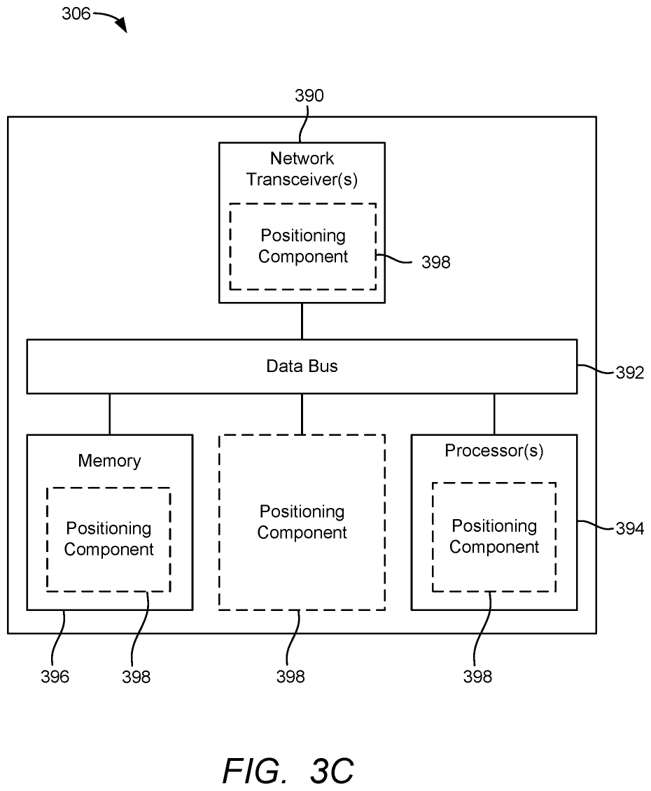

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi®, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi® transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning components 348, 388, and 398, respectively. The positioning components 348, 388, and 398 may be hardware circuits that are part of or coupled to the processors 342, 384, and 394, respectively, and are configured to cause the UE 302, the base station 304, and the network entity 306 to perform the functionality described herein. In other aspects, the positioning components 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol date units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi® and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi® “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure. For example, the network entity 306 may be a component of a private network that may be configured to communicate with the ULE 302 via the base station 304 or independently from the base station 304 (e.g., over a non-cellular communication link, such as Wi-Fi®).

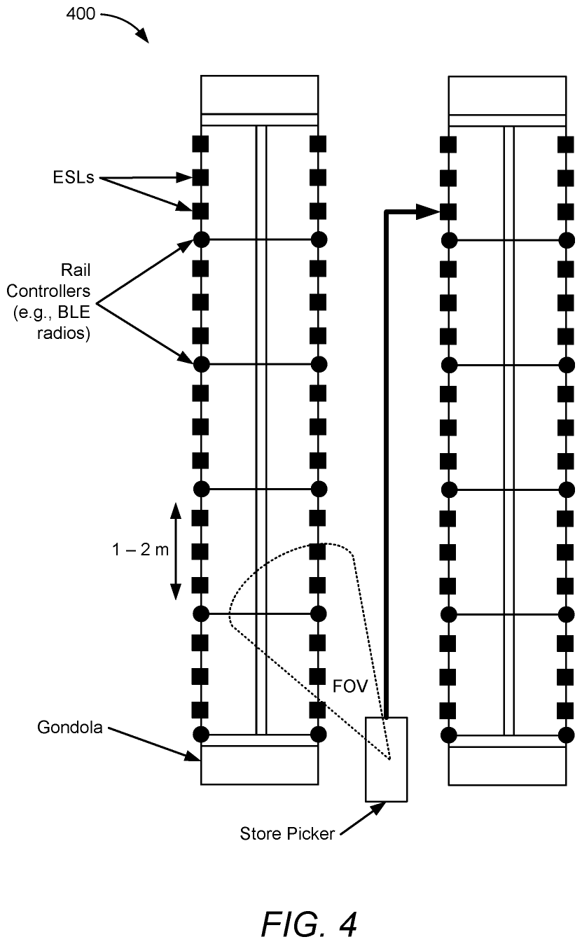

FIG. 4 is a diagram 400 illustrating an example ESL deployment scenario, according to aspects of the disclosure. Specifically, FIG. 4 illustrates a top view of a scenario where ESLs (e.g., ESLs 140) are deployed on both sides of two aisles of shelves in a retail establishment, warehouse, or the like. In the example of FIG. 4, groups of three ESLs are connected to a rail controller (e.g., a radio controller 130 utilizing, for example, a BLE radio) and the rail controllers are spaced 1 m to 2 m apart. However, as will be appreciated, this is merely an example configuration and there may be more or fewer ESLs per rail controller spaced closer or further apart.

In some cases, the ESLs may not be equipped with short-range wireless communications radios (e.g., BLE radios), and instead, the rail controller may include the short-range wireless communications radio for the three ESLs connected to it. In either case, the radio associated with an ESL (whether a component of the ESL of the rail controller to which the ESL is connected) may be referred to as an “ESL radio.” Note that, as an ESL may include a radio (see, e.g., FIG. 2), the term “ESL” may also refer to the ESL radio. Where the radio is explicitly not included in the ESL, the ESL may be referred to as an “ESL display.”

Indoor positioning based on BLE beaconing from ESLs is being developed for retail and warehouse applications. ESL radio infrastructure can be repurposed and used for position estimation, as ESL radios present a highly-dense network of anchor nodes that can achieve sub-meter accuracy in indoor venues (such as shops, retail stores, warehouses, etc.), albeit with constraints on power consumption (since they are typically battery-powered).

In general, the location of a target device (e.g., an energy harvesting tag (eTag)) is determined based on signal strength measurements (e.g., received signal strength indicator (RSSI)) of beacon signals transmitted by multiple ESLs. Trilateration using RSSI has been observed to be highly unreliable, as the RSSI is very susceptible to attenuation, which in turn leads to poor range estimation accuracy. Instead, the weighted centroid algorithm is considered to be much more robust to attenuation and non-line-of-sight (NLOS) effects.

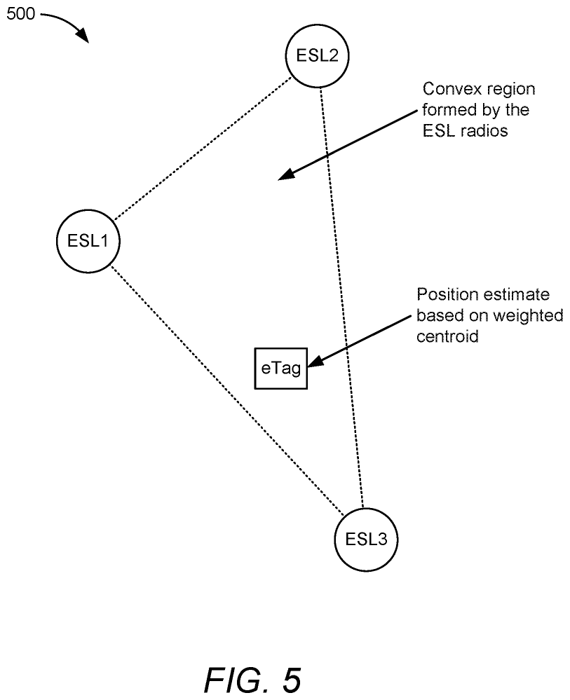

FIG. 5 is a diagram 500 illustrating an example positioning scenario using a weighted centroid algorithm, according to aspects of the disclosure. In the example of FIG. 5, measurements of the beacon signals transmitted by three ESL radios (labeled “ESL1,” “ESL2,” and “ESL3”) are used to determine a location of a target device (labeled “eTag”). For a given target device beacon transmission, let r₁≥r₂≥ . . . r_{M} denote the RSSI values of the beacon as measured by M ESL radios (in descending order). The target device position estimate is then given by the weighted average of the ESL radio positions, where the weights are a function of the RSSI values

$$\hat{P} = \frac{{\sum }_{k = 1}^{N} {w}_{k} \cdot {P}_{k}}{{\sum }_{k = 1}^{N} {w}_{k}}$$

In the above equations, N<M is the maximum number of ESL radios that are used in the computation, and wₖ is an exponential function (based on a value λ) of the RSSI values. N and λ are empirical terms that may be preset to some desired value. The weights may be proportional to the RSSIs. That is, the weight assigned to the k^{th} ESL radio is proportional to the signal strength measured by that ESL radio, meaning an ESL radio associated with a higher RSSI may be assigned a larger weight. In the example of FIG. 5, w₃>w₁>w₂.

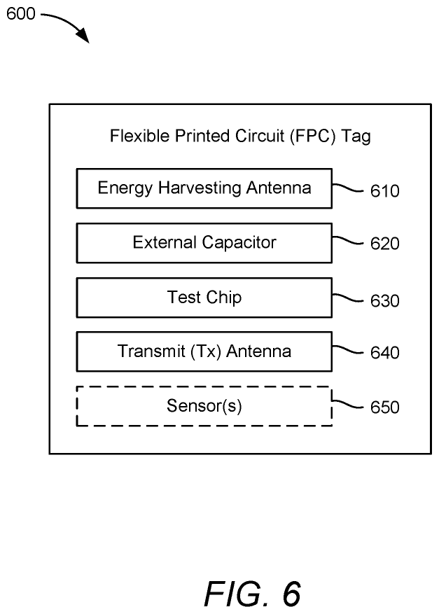

Low-cost battery-less energy harvesting “tags” (referred to as “eTags” or ambient-IoT (A-IoT) tags) are being developed that can be affixed to various types of assets for various purposes, such as positioning, tracking, verification/validation, product information storage, etc. FIG. 6 illustrates an example eTag 600, according to aspects of the disclosure. The example eTag 600 is a flexible printed circuit (FPC) having a size of, for example, 43 mm by 45 mm by 0.2 mm. In some cases, the eTag 600 may be encapsulated in a paper or plastic label with an adhesive backing that can be attached to an asset.

eTags do not include batteries, but rather, are energized by (harvest energy from) received wireless signals, similar to a radio frequency identification (RFID) tag. As such, the eTag 600 includes an energy harvesting antenna 610, which may operate in the 900 MHz range. An eTag, such as eTag 600, may be able to harvest energy from a transmitter as far away as 20 m (in contrast, an RFID tag needs to be within a few meters of the transmitter to be able to perform energy harvesting).

The energy captured by the energy harvesting antenna 610 is stored in an external capacitor 620, which in turn powers a test chip 630 and a transmit antenna 640. When powered by the external capacitor 620, the test chip 630 provides information for transmission to the transmit antenna 640. The transmit antenna 640 may operate in the 2.4 GHz range according to one or more communication protocols (e.g., BLE, Wi-Fi®, NR). For example, the test chip 630 and transmit antenna 640 may act as a BLE beacon and support BLE advertisement transmission. Note that in some cases, the transmit antenna 640 may also act as an energy harvesting antenna. In some cases, where the energy harvesting antenna 610 and the transmit antenna 640 are the same antenna, the combination of the energy harvesting antenna 610 and the transmit antenna 640 may be referred to as a transceiver.

In some cases, the eTag 600 may include one or more sensors 650. Such sensors may include temperature sensors, pressure sensors, and/or other low energy sensors.

In some cases, to position an eTag 600 using the positioning method illustrated by FIG. 5, the eTag 600 may be energized to transmit one or more BLE beacon transmissions to nearby ESL radios (e.g., ESL1, ESL2, and ESL3). The ESL radios may report their RSSI measurements to the central management entity 110, which may calculate the position of the eTag 600 or forward the measurements to another entity for processing.

In some cases, eTags may be utilized in an ESL deployment scenario, such as illustrated in FIG. 4. For example, eTags may be attached to the boxes, pallets, or other containers holding individual products, or may be attached to the individual products themselves. In such a scenario, an eTag subsystem coexists with the ESL subsystem (e.g., the central management entity 110, the wireless communication access point 120, the rail controllers 130, and the ESLs 140). The eTag subsystem includes the eTags, multiple energizer devices deployed within the environment to power the eTags, and a gateway or edge server connected to the energizer devices.

The gateway or edge server may be shared with the ESL subsystem (e.g., it may be a central management entity 110) and may perform joint management of the ESL and eTag subsystems. For example, the gateway or edge server may pair energizer devices to access points (e.g., wireless communication access points 120) for timing synchronization across the subsystems.

The energizer devices may operate in, for example, the 900 MHz and/or 2.4 GHz range(s), depending on the energy harvesting and beacon transmission configuration of the eTags. In some cases, therefore, the energizer devices may be dual mode, meaning they can operate as RFID readers to energize the eTags and BLE devices to receive/measure the BLE beacons transmitted by the eTags. (Note, however, that as described above, the energizer devices may be located further from the eTags than they would need to be from any RFID tags.) The energizer devices may also coordinate timing synchronization between the ESL radios and the eTags. Note that in a joint ESL and eTag deployment, the ESL radios do not energize the eTags; they only receive/measure the beacon transmissions from the eTags.

An example wireless communication protocol that may be utilized to support ESL-to-AP signaling is the BLE generic attribute profile (GATT) protocol. For example, ESLs may contain a BLE GATT server, and scan result read characteristics can be defined for target device RSSI measurements (e.g., for the reporting of target RSSI measurements from ESL(s) to the ESL AP). Advantages of the BLE GATT protocol include support for bulk data read operations, allowing for accumulation and less frequent reads of target device scan results. This can be useful if there are many active target devices (e.g., battery-less energy harvesting tags (eTags)). A downside of the BLE GATT protocol is the overhead of the BLUETOOTH® asynchronous connection-oriented logical transport (ACL) connect/disconnect for every query, which results in slower response time.

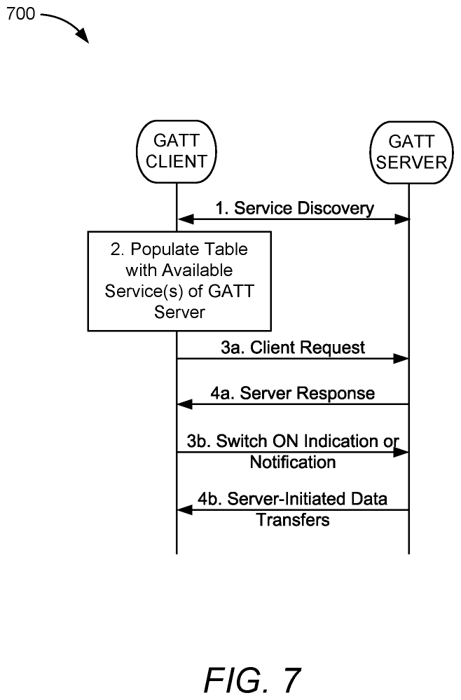

FIG. 7 illustrates an example BLE GATT procedure 700, according to aspects of the disclosure. At stage (1), a GATT client performs service discovery with a GATT server. At stage (2), the GATT client populates a table of available service(s) of the GATT server obtained from stage (1). At stage (3a), the GATT client transmits a client request to the GATT server. At stage (4a), the GATT server transmits a server response to the client request from stage (3a). As an alternative to (or in addition to) stages (3a) and (4a), at stage (3b), the GATT client may transmit a switch ON indication or notification to the GATT server, and at stage (4b), the GATT server may perform a server-initiated data transfer.

Another example wireless communications protocol that may be utilized to support ESL-to-AP signaling is the ESL periodic advertising with responses (PAWR) protocol. In ESL PAWR, ESLs can be sent a vendor-specific command via an advertising synchronization packet from the AP, and target device RSSI data can be reported by the ESL in a specific advertisement slot period. ESLs may be grouped and addressed as a group (via a group identifier (ID)). An advantage to this approach is minimum overhead and quick response time. A downside to this approach is the advertisement packet payload size is limited (48 bytes), so only one target device payload (40 bytes) may fit in one slot. As such, multiple target devices' data may need multiple slots. Note that the duration of a frame may vary from as low as 1.6 seconds to as long as 16 seconds (based on configuration).

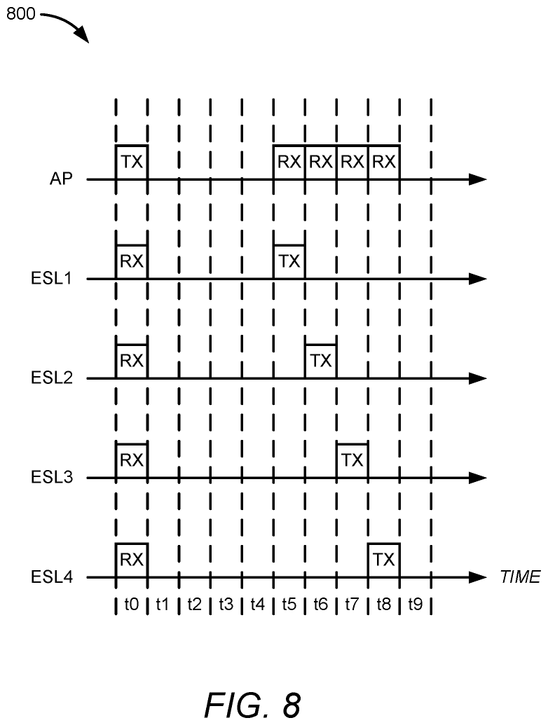

FIG. 8 illustrates an example ESL PAWR scheme 800, according to aspects of the disclosure. The ESL PAWR scheme 800 is described with respect to a cluster/group of ESLs that includes four ESLs, denoted as ESLs 1-4. At slot to, the ESL AP transmits scheduling information to ESLs 1-4. Assuming that ESLs 1-4 operate in ESL radio scan mode (i.e., receive (Rx) mode) during slots t1-t4 (e.g., collecting ESL measurement information), then ESLs 1-4 each transmit measurement feedback collected during the ESL radio scan mode to the ESL AP during slots t5-t8. Note that each ESL 1-4 may only wake up once every frame to listen and respond. As will be appreciated, for highly populated clusters/groups of ESLs, the measurement feedback to the ESL AP can take a significant amount of time and incur high signaling and scheduling overhead.

For uplink scheduling of eTag transmissions (i.e., transmissions from/by the eTag), the eTag first estimates the power level of the received signal (i.e., a wakeup signal (WUS) that energizes the eTag). The preamble of the WUS (denoted “WUS-P”) is used for synchronization and the received power level estimation. The eTag then determines whether it should transmit immediately or follow the Q rule.

Regarding the Q rule, the data portion of the WUS (denoted “WUS-D”) contains three bits that denote the value of a “Q” parameter. The eTag generates a random number M, where 0<=M<Q. If M==0, the eTag transmits immediately. If M>0, the eTag waits for M subframes and then transmits. After one transmission, the eTag waits for N subframes for another transmission attempt. In this way, the Q-value indicated in the WUS-D is proportional to a backoff delay imposed on the eTag.

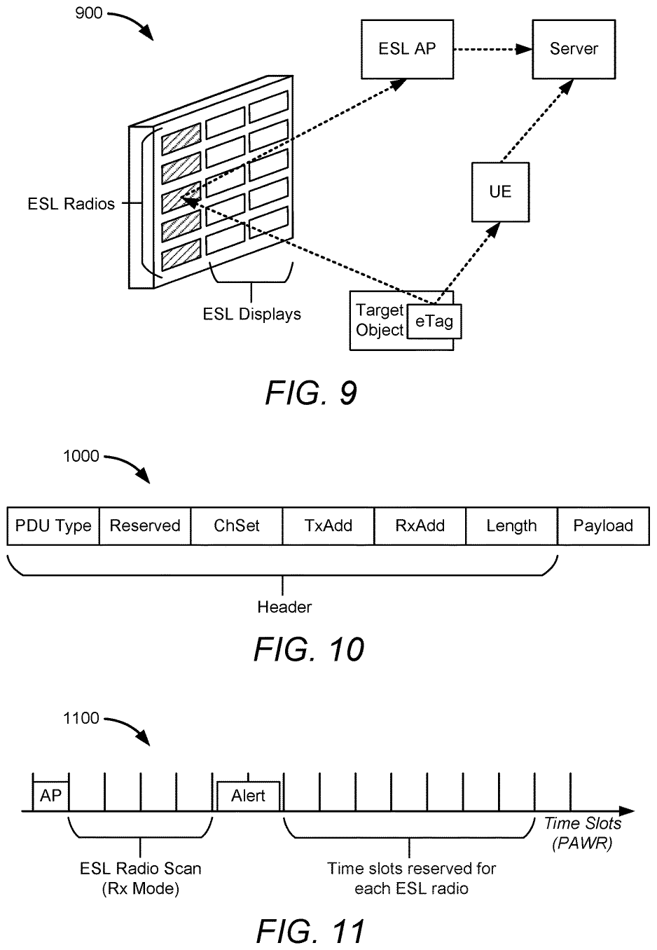

The present disclosure provides techniques for indicating the criticality of eTag transmissions to enable, for example, a real-time alert system. FIG. 9 is a diagram 900 illustrating an example scenario for indicating the criticality of eTag transmissions, according to aspects of the disclosure. The scenario illustrated in FIG. 9 involves a set of ESL radios and a set of ESL displays located on, for example, a shelving unit of a retail store or warehouse, an ESL AP (e.g., wireless communication access point 120), a server (e.g., central management entity 110), a UE (e.g., UE 302), and a target object to which an eTag (e.g., eTag 600) is affixed. The ESL radios illustrated in FIG. 9 may be wireless radios associated with the rails to which the ESLs are attached (e.g., rail controllers 130) or standalone ESLs. The ESL displays may be ESLs without integrated radios. The dashed arrows from the ELS radios to the UE(s) and other device(s) represent ESL radio beacons.

To indicate the criticality of an eTag transmission, the eTag includes one or more flag bits (also referred to as QoS information) in the uplink transmission to represent the criticality (or importance or priority) of the payload of the transmission. For example, if the eTag is reporting sensor data, a temperature exceeding −5 degrees Celsius may be indicated by a flag bit pattern of “1,” while a temperature exceeding 15 degrees Celsius may be indicated by a flag bit pattern of “11.” As another example, the flag bit(s) may indicate that one or more components are not working as expected (such as a capacitor not charging fully, sensor not reporting measurements, etc.).

In some cases, the WUS-D portion of the energizer waveform may provide the eTag with control information. This control information may indicate the criteria or threshold for criticality (such as a temperature exceeding −5 degrees Celsius). The control information may also indicate the mapping between a Q-value and the level of criticality. For example, it may be that Q=0 for high criticality and Q=16 for low/no criticality. In this case, the currently-defined Q-rule in the eTag firmware may be modified at the time of manufacture (as the logic is hard-wired).

FIG. 10 illustrates an example data packet 1000 that may be used by an eTag for uplink transmissions, according to aspects of the disclosure. The data packet 1000 may be configured according to the advertisement packet data format for the BLE protocol. As shown in FIG. 10, the example data packet 1000 includes a header portion and a payload portion. The header portion may include a PDU Type field (indicating a protocol type of the data packet), a Reserved field, a selected channel field (denoted “ChSel”), an address of the transmitter field (denoted “TxAdd”), an address of the receiver field (denoted “RxAdd”), and a Length field (indicating the length of the payload).

In some cases, the flag bit(s) indicating the criticality of the payload may be “outside encryption” (i.e., within an unencrypted portion of a packet) so they can be extracted by a relay node (e.g., an ESL radio or UE), even without possession of the decryption keys (since relay nodes typically do not have the decryption keys to decode and examine the payload, in the interest of cybersecurity and power conservation). For example, the flag bit(s) (or QoS information) may be contained in the Reserved field of the packet header, as this field does not require decryption.

In some cases, an eTag may also set a larger value for the time-to-live (TTL) counter in proportion to the criticality of the information being conveyed. The TTL determines the number of hops a packet can make before it is discarded. Each time a packet is relayed by a node, the TTL value is decremented by one. For example, with reference to FIG. 9, when the eTag transmits a data packet, it may be relayed by the UE (one hop) to the server or by an ESL radio to the ESL AP (two hops) to the server.

Based on the flag bit(s) (QoS information) received in a data packet from an eTag, one or more of the following may be performed: (1) routing prioritization by relay nodes and/or (2) adaptive scheduling by the server or other management entity. With respect to routing prioritization by relay nodes (e.g., one or more ESL radios, ESL APs, and/or UEs, as shown in FIG. 9), one or more operations may be performed. First, the relay node(s) may relay the eTag payload when the flag bit(s) (QoS information) indicates criticality (e.g., the flag bitmap is “11,” indicating high priority or urgency), and similarly not relay the payload when the flag bit(s) indicate that the information is not critical (e.g., the flag bitmap is “00,” indicating no/low priority or urgency).

Second, in the case a relay node receives data packets from multiple eTags, the relay node may select a threshold number of eTags whose data is to be relayed (which is equivalent to selecting a threshold number of data packets to be relayed). The relay node may rank the eTags (or packets) based on the flag bit(s) (QoS information) in the corresponding packets, where a higher criticality corresponds to a higher ranking. This ranking (or prioritization) of eTags (or packets) may be applied when the relay node receives multiple data packets at substantially the same time and cannot relay all of them in a timely manner or without incurring some other cost (e.g., excessive battery usage).

As a third operation, a relay node may send a small/short “alert packet” (in place of the entire eTag payload) when the flag bit(s) (QoS information) indicates criticality. Such an alert packet may contain just the header of the eTag packet, such as eTag ID and the flag bit(s).

Where the relay node is an ESL radio, the ESL radio may send such an alert packet during a dedicated set of time slots that is allocated for such scenarios by the ESL AP (e.g., as part of a PAWR scheme). These dedicated time slots may be used by any ESL radio to send an alert packet, even during a subframe that the ESL radio is not associated with (e.g., not mentioned in the group ID associated with that subframe).

FIG. 11 is a diagram 1100 illustrating an example portion of a subframe in which a dedicated set of slots is allocated for the transmission of alert packets, according to aspects of the disclosure. As shown in FIG. 11, an AP synchronization beacon (denoted “AP”) is transmitted in the first slot, the next four slots are for ESL radio scanning (i.e., receive (Rx) mode), and the next two slots are allocated for alert packets. These slots may be used by any ESL radio to send alert packets, even if an ESL radio is not configured to transmit during that subframe. The next seven slots are reserved for each ESL radio in a particular group under default operation.

In some cases, the server may configure one or more channel access schemes to the ESL radios (via the ESL AP, which embeds this information in the scheduling information in its synchronization beacon) for handling uplink interference among multiple ESL radios that intend to send an alert packet (since multiple ESL radios may receive an eTag payload with high criticality and need to send an alert packet). In some cases, the channel access scheme may be a time-division multiple-access (TDMA) scheme. In this case, given a dedicated set of time slots for the alert packets (as shown in FIG. 11), an ESL radio may randomly select one of the time slots to send the alert packet. In some cases, the channel access scheme may be a

In some cases, the channel access scheme may be a carrier-sense multiple access with collision avoidance (CSMA-CA) scheme. In this case, for a given time slot, an ESL radio waits for a fixed period of time (e.g., 50 microseconds (μs)) before sending the alert packet. If an ESL radio senses (receives) another transmission during this fixed period, then it backs off from the channel and does not send an alert packet during that time slot.

In some cases, the channel access scheme may be a frequency-division multiple-access (FDMA) scheme. In this case, a set of advertisement channels (e.g., BLE channels 37, 38, 39) and/or data channels may be indicated by the ESL AP, and an ESL radio may randomly select one of the channels to send the alert packet. These channels may also be dedicated to the transmission of alert packets alone.

Referring now to adaptive scheduling by the server or other management entity (e.g., central management entity 110), the server may provide various indications to one or more ESL radios (via the ESL AP). These indications may include an initial schedule, which may include a first number of dedicated/reserved time slots for alert packets for all ESL radios. This number may be relatively small, even zero.

When an alert packet is received from one or more ESL radios (where the alert packet may have been sent over the dedicated time slots or over the default response slot assigned for those ESL radio(s)), the server may allocate a second number of dedicated/reserved time slots for alert packets. This second set of dedicated time slots may be allocated during all subframes associated with the ESL radios in a subsequent cycle/frame. The second number of dedicated time slots may be larger than the first number of dedicated time slots.

Where a UE can serve as a relay node, the server may (1) allocate no dedicated time slots for alert packets to be sent by one or more ESL radios within a threshold distance of a location estimate of the UE and/or (2) indicate to the ESL radios to not send alert packets.

In response to a threshold number of alert packet(s) being received at the server from a given eTag, the server may indicate to an ESL radio to send complete payload information pertaining to that eTag in its subsequent (relayed) transmissions. More specifically, an alert packet may be interpreted as being “critical header information,” such as a brief description of what the criticality is (e.g., a type of the criticality, a level of the criticality). In response to such header information, the server may request the complete payload of the eTag packet as well, which may contain more details about the emergency, related measurements, etc.

With continued reference to adaptive scheduling by the server, the server may also provide various indications to one or more energizer devices. Here, in response to the server receiving a criticality indication (indicating high criticality) corresponding to one or more eTags, the server may indicate to one or more energizer devices to boost transmission power (which may or may not involve beamforming) to improve the energizing coverage for those eTags. The server may also indicate to one or more energizer devices to reduce the Q-value in the WUS-D portion of the energizing signal for those eTags. This has the effect of reducing channel access delay/latency for the eTag(s) so that subsequent information that is potentially critical can be sent by the eTag(s) with lower latency. In some cases, the server may provide a coarse location estimate for the eTag(s) as assistance data to the energizer devices to enable the above functionalities.

Note that while the foregoing has generally described the disclosed techniques in terms of ESL radios and ESL APs, as will be appreciated, the techniques described herein are equally applicable to other types of wireless relay nodes (including UEs) and associated access points (if present/applicable) that transmit in allocated time slots.

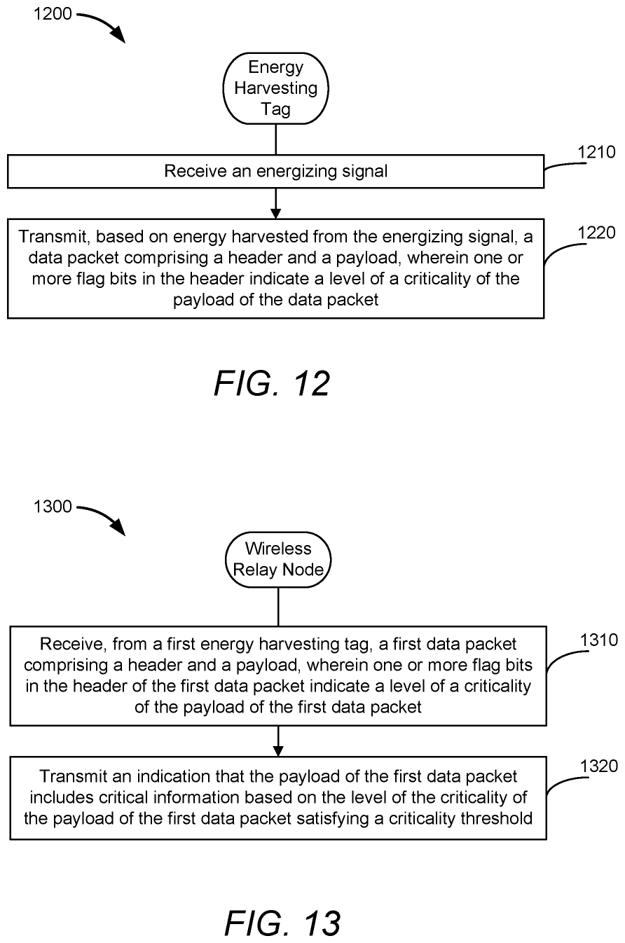

FIG. 12 illustrates an example method 1200 of wireless communication, according to aspects of the disclosure. In an aspect, method 1200 may be performed by an energy harvesting tag (e.g., any of the eTags described herein).

At operation 1210, the energy harvesting tag (eTag) may receive an energizing signal.

In an aspect, operation 1210 may be performed by the energy harvesting antenna 610 and/or the external capacitor 620, any or all of which may be considered means for performing this operation.

At operation 1220, the energy harvesting tag may transmit, based on (i.e., using) energy harvested from the energizing signal, a data packet (e.g., data packet 1000) having a header and a payload, where one or more flag bits in the header indicate a level of a criticality of the payload of the data packet.

In an aspect, operation 1220 may be performed by the energy harvesting antenna 610, the external capacitor 620, the test chip 630, the transmit antenna 640, and/or the sensor(s) 650, any or all of which may be considered means for performing this operation.

FIG. 13 illustrates an example method 1300 of wireless communication, according to aspects of the disclosure. In an aspect, method 1300 may be performed by a wireless relay node (e.g., any of the UEs or ESL radios described herein).

At operation 1310, the wireless relay node may receive, from a first energy harvesting tag (eTag), a first data packet (e.g., data packet 1000) having a header and a payload, where one or more flag bits in the header of the first data packet indicate a level of a criticality of the payload of the first data packet.

In an aspect, where the wireless relay node is a UE, operation 1310 may be performed by the one or more WWAN transceivers 310, the one or more short-range wireless transceivers 320, the one or more processors 342, memory 340, and/or positioning component 348, any or all of which may be considered means for performing this operation.

In an aspect, where the wireless relay node is an ESL radio, operation 1310 may be performed by the radio, microcontroller unit, and/or power management unit illustrated in FIG. 2, any or all of which may be considered means for performing this operation.

In an aspect, where the wireless relay node is a base station or base station component, operation 1310 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

At operation 1320, the wireless relay node may transmit an indication that the payload of the first data packet includes critical information based on the level of the criticality of the payload of the first data packet satisfying a criticality threshold.

In an aspect, where the wireless relay node is a UE, operation 1320 may be performed by the one or more WWAN transceivers 310, the one or more short-range wireless transceivers 320, the one or more processors 342, memory 340, and/or positioning component 348, any or all of which may be considered means for performing this operation.

In an aspect, where the wireless relay node is an ESL radio, operation 1320 may be performed by the radio, microcontroller unit, and/or power management unit illustrated in FIG. 2, any or all of which may be considered means for performing this operation.

In an aspect, where the wireless relay node is a base station or base station component, operation 1320 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

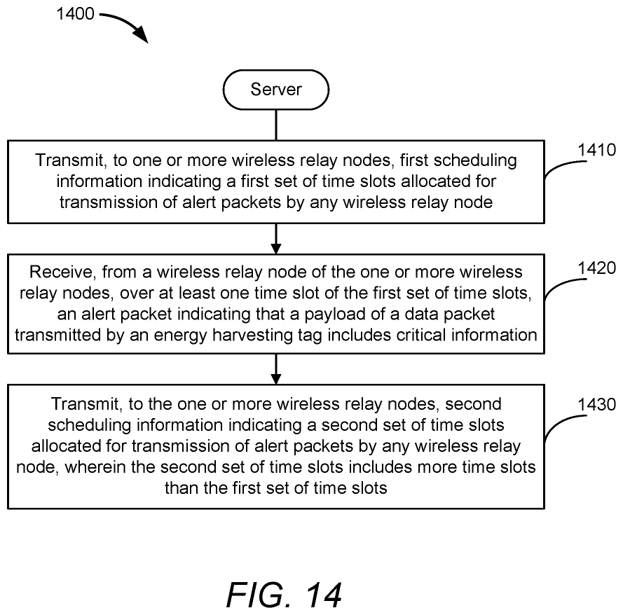

FIG. 14 illustrates an example method 1400 of communication, according to aspects of the disclosure. In an aspect, method 1400 may be performed by a server (e.g., any of the UEs, base stations, or network entities described herein).

At operation 1410, the server may transmit, to one or more wireless relay nodes, first scheduling information indicating a first set of time slots allocated for transmission of alert packets by any wireless relay node.

In an aspect, where the server is a UE, operation 1410 may be performed by the one or more WWAN transceivers 310, the one or more short-range wireless transceivers 320, the one or more processors 342, memory 340, and/or positioning component 348, any or all of which may be considered means for performing this operation.

In an aspect, where the server is a base station or base station component, operation 1410 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1410 may be performed by the one or more network transceivers 390, the one or more processors 394, memory 396, and/or positioning component 398, any or all of which may be considered means for performing this operation.

At operation 1420, the server may receive, from a wireless relay node of the one or more wireless relay nodes, over at least one time slot of the first set of time slots, an alert packet indicating that a payload of a data packet (e.g., data packet 1000) transmitted by an energy harvesting tag (eTag) includes critical information.

In an aspect, where the server is a UE, operation 1420 may be performed by the one or more WWAN transceivers 310, the one or more short-range wireless transceivers 320, the one or more processors 342, memory 340, and/or positioning component 348, any or all of which may be considered means for performing this operation.

In an aspect, where the server is a base station or base station component, operation 1420 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1420 may be performed by the one or more network transceivers 390, the one or more processors 394, memory 396, and/or positioning component 398, any or all of which may be considered means for performing this operation.

At operation 1430, the server may transmit, to the one or more wireless relay nodes, second scheduling information indicating a second set of time slots allocated for transmission of alert packets by any wireless relay node, where the second set of time slots includes more time slots than the first set of time slots.

In an aspect, where the server is a UE, operation 1430 may be performed by the one or more WWAN transceivers 310, the one or more short-range wireless transceivers 320, the one or more processors 342, memory 340, and/or positioning component 348, any or all of which may be considered means for performing this operation.

In an aspect, where the server is a base station or base station component, operation 1430 may be performed by the one or more WWAN transceivers 350, the one or more short-range wireless transceivers 360, the one or more network transceivers 380, the one or more processors 384, memory 386, and/or positioning component 388, any or all of which may be considered means for performing this operation.

In an aspect, where the server is a network entity, operation 1430 may be performed by the one or more network transceivers 390, the one or more processors 394, memory 396, and/or positioning component 398, any or all of which may be considered means for performing this operation.

Note that while the foregoing has generally referred to ESLs, the techniques of the present disclosure are applicable to any type of electronic label display.

As will be appreciated, a technical advantage of the methods 1200, 1300, and 1400 is rapid identification and routing of critical data to the server, thereby enhancing real-time alert systems for emergencies such as fires or sudden temperature changes

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1: A method of wireless communication performed by an energy harvesting tag, comprising: receiving an energizing signal; and transmitting, based on energy harvested from the energizing signal, a data packet comprising a header and a payload, wherein one or more flag bits in the header indicate a level of a criticality of the payload of the data packet.

Clause 2: The method of clause 1, wherein the energizing signal indicates one or more thresholds for determining the level of the criticality of the payload.

Clause 3: The method of any of clauses 1 to 2, wherein the energizing signal indicates a mapping between a number of subframes to wait to transmit the data packet and the level of the criticality of the payload.

Clause 4: The method of any of clauses 1 to 3, wherein the one or more flag bits are in an unencrypted field of the header of the data packet.

Clause 5: The method of any of clauses 1 to 4, wherein a time-to-live (TTL) value associated with the data packet is proportional to the level of the criticality of the payload.

Clause 6: A method of wireless communication performed by a wireless relay node, comprising: receiving, from a first energy harvesting tag, a first data packet comprising a header and a payload, wherein one or more flag bits in the header of the first data packet indicate a level of a criticality of the payload of the first data packet; and transmitting an indication that the payload of the first data packet includes critical information based on the level of the criticality of the payload of the first data packet satisfying a criticality threshold.

Clause 7: The method of clause 6, further comprising: receiving, from a second energy harvesting tag, a second data packet comprising a header and a payload, wherein one or more flag bits in the header of the second data packet indicate a level of a criticality of the payload of the second data packet, wherein the level of the criticality of the payload of the second data packet satisfies the criticality threshold, and wherein the indication that the payload of the first data packet includes critical information is transmitted based on a determination that the level of the criticality of the payload of the second data packet is lower than the level of the criticality of the payload of the first data packet.

Clause 8: The method of any of clauses 6 to 7, further comprising: decrementing a time-to-live (TTL) value associated with the first data packet, wherein the TTL value is proportional to the level of the criticality of the payload of the first data packet.

Clause 9: The method of any of clauses 6 to 8, wherein the indication that the payload of the first data packet includes critical information is the payload of the first data packet.

Clause 10: The method of any of clauses 6 to 9, wherein the indication that the payload of the first data packet includes critical information is an alert packet including the header of the first data packet.

Clause 11: The method of any of clauses 6 to 10, wherein the alert packet is transmitted in one or more time slots allocated for transmission of alert packets by any wireless relay node.

Clause 12: The method of any of clauses 6 to 11, further comprising: receiving a channel access scheme for transmission of the alert packet, wherein the alert packet is transmitted in the one or more time slots according to the channel access scheme.

Clause 13: The method of any of clauses 6 to 12, wherein the channel access scheme is: a time-division multiple-access (TDMA) scheme; a frequency-division multiple-access (FDMA) scheme; or a carrier-sense multiple access with collision avoidance (CSMA-CA) scheme.

Clause 14: A method of communication performed by a server, comprising: transmitting, to one or more wireless relay nodes, first scheduling information indicating a first set of time slots allocated for transmission of alert packets by any wireless relay node; receiving, from a wireless relay node of the one or more wireless relay nodes, over at least one time slot of the first set of time slots, an alert packet indicating that a payload of a data packet transmitted by an energy harvesting tag includes critical information; and transmitting, to the one or more wireless relay nodes, second scheduling information indicating a second set of time slots allocated for transmission of alert packets by any wireless relay node, wherein the second set of time slots includes more time slots than the first set of time slots.

Clause 15: The method of clause 14, wherein: the wireless relay node is a user equipment (UE); and no time slots are allocated to one or more wireless radios associated with electronic label devices to transmit alert packets from energy harvesting tags based on the one or more wireless radios being within a threshold distance of a location of the UE.

Clause 16: The method of any of clauses 14 to 15, further comprising: transmitting, to the wireless relay node, a request to provide payload information for the energy harvesting tag in a next relay transmission for the wireless relay node based on reception at the server of a threshold number of alert packets associated with the energy harvesting tag.

Clause 17: The method of any of clauses 14 to 16, wherein the alert packet includes: a description of the critical information; header information from the data packet; or a combination thereof.

Clause 18: The method of any of clauses 14 to 17, further comprising: transmitting, to one or more energizer devices, a request to increase transmission power to increase energizing coverage of the energy harvesting tag.

Clause 19: The method of any of clauses 14 to 18, further comprising: transmitting, to one or more energizer devices, a request to decrease a number of subframes for the energy harvesting tag to wait to transmit data packets.

Clause 20: The method of any of clauses 14 to 19, further comprising: transmitting, to one or more energizer devices, a location estimate of the energy harvesting tag.

Clause 21: An energy harvesting tag, comprising: one or more memories; one or more antennas; and one or more processors communicatively coupled to the one or more memories and the one or more transceivers, the one or more processors, either alone or in combination, configured to: receive, via the one or more antennas, an energizing signal; and transmit, via the one or more antennas, based on energy harvested from the energizing signal, a data packet comprising a header and a payload, wherein one or more flag bits in the header indicate a level of a criticality of the payload of the data packet.

Clause 22: The energy harvesting tag of clause 21, wherein the energizing signal indicates one or more thresholds for determining the level of the criticality of the payload.

Clause 23: The energy harvesting tag of any of clauses 21 to 22, wherein the energizing signal indicates a mapping between a number of subframes to wait to transmit the data packet and the level of the criticality of the payload.

Clause 24: The energy harvesting tag of any of clauses 21 to 23, wherein the one or more flag bits are in an unencrypted field of the header of the data packet.

Clause 25: The energy harvesting tag of any of clauses 21 to 24, wherein a time-to-live (TTL) value associated with the data packet is proportional to the level of the criticality of the payload.

Clause 26: A wireless relay node, comprising: one or more memories; one or more transceivers; and one or more processors communicatively coupled to the one or more memories and the one or more transceivers, the one or more processors, either alone or in combination, configured to: receive, via the one or more transceivers, from a first energy harvesting tag, a first data packet comprising a header and a payload, wherein one or more flag bits in the header of the first data packet indicate a level of a criticality of the payload of the first data packet; and transmit, via the one or more transceivers, an indication that the payload of the first data packet includes critical information based on the level of the criticality of the payload of the first data packet satisfying a criticality threshold.

Clause 27: The wireless relay node of clause 26, wherein the one or more processors, either alone or in combination, are further configured to: receive, via the one or more transceivers, from a second energy harvesting tag, a second data packet comprising a header and a payload, wherein one or more flag bits in the header of the second data packet indicate a level of a criticality of the payload of the second data packet; wherein the level of the criticality of the payload of the second data packet satisfies the criticality threshold; and wherein the indication that the payload of the first data packet includes critical information is transmitted based on a determination that the level of the criticality of the payload of the second data packet is lower than the level of the criticality of the payload of the first data packet.

Clause 28: The wireless relay node of any of clauses 26 to 27, wherein the one or more processors, either alone or in combination, are further configured to: decrement a time-to-live (TTL) value associated with the first data packet, wherein the TTL value is proportional to the level of the criticality of the payload of the first data packet.

Clause 29: The wireless relay node of any of clauses 26 to 28, wherein the indication that the payload of the first data packet includes critical information is the payload of the first data packet.

Clause 30: The wireless relay node of any of clauses 26 to 29, wherein the indication that the payload of the first data packet includes critical information is an alert packet including the header of the first data packet.

Clause 31: The wireless relay node of any of clauses 26 to 30, wherein the alert packet is transmitted in one or more time slots allocated for transmission of alert packets by any wireless relay node.

Clause 32: The wireless relay node of any of clauses 26 to 31, wherein the one or more processors, either alone or in combination, are further configured to: receive, via the one or more transceivers, a channel access scheme for transmission of the alert packet, wherein the alert packet is transmitted in the one or more time slots according to the channel access scheme.

Clause 33: The wireless relay node of any of clauses 26 to 32, wherein the channel access scheme is: a time-division multiple-access (TDMA) scheme; a frequency-division multiple-access (FDMA) scheme; or a carrier-sense multiple access with collision avoidance (CSMA-CA) scheme.

Clause 34: A server, comprising: one or more memories; one or more transceivers; and one or more processors communicatively coupled to the one or more memories and the one or more transceivers, the one or more processors, either alone or in combination, configured to: transmit, via the one or more transceivers, to one or more wireless relay nodes, first scheduling information indicating a first set of time slots allocated for transmission of alert packets by any wireless relay node; receive, via the one or more transceivers, from a wireless relay node of the one or more wireless relay nodes, over at least one time slot of the first set of time slots, an alert packet indicating that a payload of a data packet transmitted by an energy harvesting tag includes critical information; and transmit, via the one or more transceivers, to the one or more wireless relay nodes, second scheduling information indicating a second set of time slots allocated for transmission of alert packets by any wireless relay node, wherein the second set of time slots includes more time slots than the first set of time slots.

Clause 35: The server of clause 34, wherein: the wireless relay node is a user equipment (UE); and no time slots are allocated to one or more wireless radios associated with electronic label devices to transmit alert packets from energy harvest tags based on the one or more wireless radios being within a threshold distance of a location of the UE.

Clause 36: The server of any of clauses 34 to 35, wherein the one or more processors, either alone or in combination, are further configured to: transmit, via the one or more transceivers, to the wireless relay node, a request to provide payload information for the energy harvesting tag in a next relay transmission for the wireless relay node based on reception at the server of a threshold number of alert packets associated with the energy harvesting tag.

Clause 37: The server of any of clauses 34 to 36, wherein the alert packet includes: a description of the critical information; header information from the data packet; or a combination thereof.

Clause 38: The server of any of clauses 34 to 37, wherein the one or more processors, either alone or in combination, are further configured to: transmit, via the one or more transceivers, to one or more energizer devices, a request to increase transmission power to increase energizing coverage of the energy harvesting tag.

Clause 39: The server of any of clauses 34 to 38, wherein the one or more processors, either alone or in combination, are further configured to: transmit, via the one or more transceivers, to one or more energizer devices, a request to decrease a number of subframes for the energy harvesting tag to wait to transmit data packets.

Clause 40: The server of any of clauses 34 to 39, wherein the one or more processors, either alone or in combination, are further configured to: transmit, via the one or more transceivers, to one or more energizer devices, a location estimate of the energy harvesting tag.

Clause 41: An energy harvesting tag, comprising: means for receiving an energizing signal; and means for transmitting, based on energy harvested from the energizing signal, a data packet comprising a header and a payload, wherein one or more flag bits in the header indicate a level of a criticality of the payload of the data packet.

Clause 42: The energy harvesting tag of clause 41, wherein the energizing signal indicates one or more thresholds for determining the level of the criticality of the payload.

Clause 43: The energy harvesting tag of any of clauses 41 to 42, wherein the energizing signal indicates a mapping between a number of subframes to wait to transmit the data packet and the level of the criticality of the payload.

Clause 44: The energy harvesting tag of any of clauses 41 to 43, wherein the one or more flag bits are in an unencrypted field of the header of the data packet.

Clause 45: The energy harvesting tag of any of clauses 41 to 44, wherein a time-to-live (TTL) value associated with the data packet is proportional to the level of the criticality of the payload.

Clause 46: A wireless relay node, comprising: means for receiving, from a first energy harvesting tag, a first data packet comprising a header and a payload, wherein one or more flag bits in the header of the first data packet indicate a level of a criticality of the payload of the first data packet; and means for transmitting an indication that the payload of the first data packet includes critical information based on the level of the criticality of the payload of the first data packet satisfying a criticality threshold.

Clause 47: The wireless relay node of clause 46, further comprising: means for receiving, from a second energy harvesting tag, a second data packet comprising a header and a payload, wherein one or more flag bits in the header of the second data packet indicate a level of a criticality of the payload of the second data packet; wherein the level of the criticality of the payload of the second data packet satisfies the criticality threshold; and wherein the indication that the payload of the first data packet includes critical information is transmitted based on a determination that the level of the criticality of the payload of the second data packet is lower than the level of the criticality of the payload of the first data packet.

Clause 48: The wireless relay node of any of clauses 46 to 47, further comprising: means for decrementing a time-to-live (TTL) value associated with the first data packet, wherein the TTL value is proportional to the level of the criticality of the payload of the first data packet.

Clause 49: The wireless relay node of any of clauses 46 to 48, wherein the indication that the payload of the first data packet includes critical information is the payload of the first data packet.

Clause 50: The wireless relay node of any of clauses 46 to 49, wherein the indication that the payload of the first data packet includes critical information is an alert packet including the header of the first data packet.

Clause 51: The wireless relay node of any of clauses 46 to 50, wherein the alert packet is transmitted in one or more time slots allocated for transmission of alert packets by any wireless relay node.

Clause 52: The wireless relay node of any of clauses 46 to 51, further comprising: means for receiving a channel access scheme for transmission of the alert packet, wherein the alert packet is transmitted in the one or more time slots according to the channel access scheme.

Clause 53: The wireless relay node of any of clauses 46 to 52, wherein the channel access scheme is: a time-division multiple-access (TDMA) scheme; a frequency-division multiple-access (FDMA) scheme; or a carrier-sense multiple access with collision avoidance (CSMA-CA) scheme.

Clause 54: A server, comprising: means for transmitting, to one or more wireless relay nodes, first scheduling information indicating a first set of time slots allocated for transmission of alert packets by any wireless relay node; means for receiving, from a wireless relay node of the one or more wireless relay nodes, over at least one time slot of the first set of time slots, an alert packet indicating that a payload of a data packet transmitted by an energy harvesting tag includes critical information; and means for transmitting, to the one or more wireless relay nodes, second scheduling information indicating a second set of time slots allocated for transmission of alert packets by any wireless relay node, wherein the second set of time slots includes more time slots than the first set of time slots.

Clause 55: The server of clause 54, wherein: the wireless relay node is a user equipment (UE); and no time slots are allocated to one or more wireless radios associated with electronic label devices to transmit alert packets from energy harvesting tags based on the one or more wireless radios being within a threshold distance of a location of the UE.

Clause 56: The server of any of clauses 54 to 55, further comprising: means for transmitting, to the wireless relay node, a request to provide payload information for the energy harvesting tag in a next relay transmission for the wireless relay node based on reception at the server of a threshold number of alert packets associated with the energy harvesting tag.

Clause 57: The server of any of clauses 54 to 56, wherein the alert packet includes: a description of the critical information; header information from the data packet; or a combination thereof.

Clause 58: The server of any of clauses 54 to 57, further comprising: means for transmitting, to one or more energizer devices, a request to increase transmission power to increase energizing coverage of the energy harvesting tag.

Clause 59: The server of any of clauses 54 to 58, further comprising: means for transmitting, to one or more energizer devices, a request to decrease a number of subframes for the energy harvesting tag to wait to transmit data packets.

Clause 60: The server of any of clauses 54 to 59, further comprising: means for transmitting, to one or more energizer devices, a location estimate of the energy harvesting tag.

Clause 61: A non-transitory computer-readable medium storing computer-executable instructions that, when executed by an energy harvesting tag, cause the energy harvesting tag to: receive an energizing signal; and transmit, based on energy harvested from the energizing signal, a data packet comprising a header and a payload, wherein one or more flag bits in the header indicate a level of a criticality of the payload of the data packet.

Clause 62: The non-transitory computer-readable medium of clause 61, wherein the energizing signal indicates one or more thresholds for determining the level of the criticality of the payload.

Clause 63: The non-transitory computer-readable medium of any of clauses 61 to 62, wherein the energizing signal indicates a mapping between a number of subframes to wait to transmit the data packet and the level of the criticality of the payload.

Clause 64: The non-transitory computer-readable medium of any of clauses 61 to 63, wherein the one or more flag bits are in an unencrypted field of the header of the data packet.

Clause 65: The non-transitory computer-readable medium of any of clauses 61 to 64, wherein a time-to-live (TTL) value associated with the data packet is proportional to the level of the criticality of the payload.

Clause 66: A non-transitory computer-readable medium storing computer-executable instructions that, when executed by a wireless relay node, cause the wireless relay node to: receive, from a first energy harvesting tag, a first data packet comprising a header and a payload, wherein one or more flag bits in the header of the first data packet indicate a level of a criticality of the payload of the first data packet; and transmit an indication that the payload of the first data packet includes critical information based on the level of the criticality of the payload of the first data packet satisfying a criticality threshold.

Clause 67: The non-transitory computer-readable medium of clause 66, further comprising computer-executable instructions that, when executed by the wireless relay node, cause the wireless relay node to: receive, from a second energy harvesting tag, a second data packet comprising a header and a payload, wherein one or more flag bits in the header of the second data packet indicate a level of a criticality of the payload of the second data packet; wherein the level of the criticality of the payload of the second data packet satisfies the criticality threshold; and wherein the indication that the payload of the first data packet includes critical information is transmitted based on a determination that the level of the criticality of the payload of the second data packet is lower than the level of the criticality of the payload of the first data packet.

Clause 68: The non-transitory computer-readable medium of any of clauses 66 to 67, further comprising computer-executable instructions that, when executed by the wireless relay node, cause the wireless relay node to: decrement a time-to-live (TTL) value associated with the first data packet, wherein the TTL value is proportional to the level of the criticality of the payload of the first data packet.

Clause 69: The non-transitory computer-readable medium of any of clauses 66 to 68, wherein the indication that the payload of the first data packet includes critical information is the payload of the first data packet.

Clause 70: The non-transitory computer-readable medium of any of clauses 66 to 69, wherein the indication that the payload of the first data packet includes critical information is an alert packet including the header of the first data packet.

Clause 71: The non-transitory computer-readable medium of any of clauses 66 to 70, wherein the alert packet is transmitted in one or more time slots allocated for transmission of alert packets by any wireless relay node.

Clause 72: The non-transitory computer-readable medium of any of clauses 66 to 71, further comprising computer-executable instructions that, when executed by the wireless relay node, cause the wireless relay node to: receive a channel access scheme for transmission of the alert packet, wherein the alert packet is transmitted in the one or more time slots according to the channel access scheme.

Clause 73: The non-transitory computer-readable medium of any of clauses 66 to 72, wherein the channel access scheme is: a time-division multiple-access (TDMA) scheme; a frequency-division multiple-access (FDMA) scheme; or a carrier-sense multiple access with collision avoidance (CSMA-CA) scheme.

Clause 74: A non-transitory computer-readable medium storing computer-executable instructions that, when executed by a server, cause the server to: transmit, to one or more wireless relay nodes, first scheduling information indicating a first set of time slots allocated for transmission of alert packets by any wireless relay node; receive, from a wireless relay node of the one or more wireless relay nodes, over at least one time slot of the first set of time slots, an alert packet indicating that a payload of a data packet transmitted by an energy harvesting tag includes critical information; and transmit, to the one or more wireless relay nodes, second scheduling information indicating a second set of time slots allocated for transmission of alert packets by any wireless relay node, wherein the second set of time slots includes more time slots than the first set of time slots.

Clause 75: The non-transitory computer-readable medium of clause 74, wherein: the wireless relay node is a user equipment (UE); and no time slots are allocated to one or more wireless radios associated with electronic label devices to transmit alert packets from energy harvest tags based on the one or more wireless radios being within a threshold distance of a location of the UE.

Clause 76: The non-transitory computer-readable medium of any of clauses 74 to 75, further comprising computer-executable instructions that, when executed by the server, cause the server to: transmit, to the wireless relay node, a request to provide payload information for the energy harvesting tag in a next relay transmission for the wireless relay node based on reception at the server of a threshold number of alert packets associated with the energy harvesting tag.

Clause 77: The non-transitory computer-readable medium of any of clauses 74 to 76, wherein the alert packet includes: a description of the critical information; header information from the data packet; or a combination thereof.

Clause 78: The non-transitory computer-readable medium of any of clauses 74 to 77, further comprising computer-executable instructions that, when executed by the server, cause the server to: transmit, to one or more energizer devices, a request to increase transmission power to increase energizing coverage of the energy harvesting tag.

Clause 79: The non-transitory computer-readable medium of any of clauses 74 to 78, further comprising computer-executable instructions that, when executed by the server, cause the server to: transmit, to one or more energizer devices, a request to decrease a number of subframes for the energy harvesting tag to wait to transmit data packets.

Clause 80: The non-transitory computer-readable medium of any of clauses 74 to 79, further comprising computer-executable instructions that, when executed by the server, cause the server to: transmit, to one or more energizer devices, a location estimate of the energy harvesting tag.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An energy harvesting tag, comprising:
one or more memories;
one or more antennas; and
one or more processors communicatively coupled to the one or more memories and the one or more transceivers, the one or more processors, either alone or in combination, configured to:
receive, via the one or more antennas, an energizing signal; and
transmit, via the one or more antennas, based on energy harvested from the energizing signal, a data packet comprising a header and a payload, wherein one or more flag bits in the header indicate a level of a criticality of the payload of the data packet.

2. The energy harvesting tag of claim 1, wherein the energizing signal indicates one or more thresholds for determining the level of the criticality of the payload.

3. The energy harvesting tag of claim 1, wherein the energizing signal indicates a mapping between a number of subframes to wait to transmit the data packet and the level of the criticality of the payload.

4. The energy harvesting tag of claim 1, wherein the one or more flag bits are in an unencrypted field of the header of the data packet.

5. The energy harvesting tag of claim 1, wherein a time-to-live (TTL) value associated with the data packet is proportional to the level of the criticality of the payload.

6. A wireless relay node, comprising:
one or more memories;
one or more transceivers; and
one or more processors communicatively coupled to the one or more memories and the one or more transceivers, the one or more processors, either alone or in combination, configured to:
receive, via the one or more transceivers, from a first energy harvesting tag, a first data packet comprising a header and a payload, wherein one or more flag bits in the header of the first data packet indicate a level of a criticality of the payload of the first data packet; and
transmit, via the one or more transceivers, an indication that the payload of the first data packet includes critical information based on the level of the criticality of the payload of the first data packet satisfying a criticality threshold.

7. The wireless relay node of claim 6, wherein the one or more processors, either alone or in combination, are further configured to:
receive, via the one or more transceivers, from a second energy harvesting tag, a second data packet comprising a header and a payload, wherein one or more flag bits in the header of the second data packet indicate a level of a criticality of the payload of the second data packet;
wherein the level of the criticality of the payload of the second data packet satisfies the criticality threshold; and
wherein the indication that the payload of the first data packet includes critical information is transmitted based on a determination that the level of the criticality of the payload of the second data packet is lower than the level of the criticality of the payload of the first data packet.

8. The wireless relay node of claim 6, wherein the one or more processors, either alone or in combination, are further configured to:
decrement a time-to-live (TTL) value associated with the first data packet, wherein the TTL value is proportional to the level of the criticality of the payload of the first data packet.

9. The wireless relay node of claim 6, wherein the indication that the payload of the first data packet includes critical information is the payload of the first data packet.

10. The wireless relay node of claim 6, wherein the indication that the payload of the first data packet includes critical information is an alert packet including the header of the first data packet.

11. The wireless relay node of claim 10, wherein the alert packet is transmitted in one or more time slots allocated for transmission of alert packets by any wireless relay node.

12. The wireless relay node of claim 11, wherein the one or more processors, either alone or in combination, are further configured to:
receive, via the one or more transceivers, a channel access scheme for transmission of the alert packet, wherein the alert packet is transmitted in the one or more time slots according to the channel access scheme.

13. The wireless relay node of claim 12, wherein the channel access scheme is:
a time-division multiple-access (TDMA) scheme;
a frequency-division multiple-access (FDMA) scheme; or
a carrier-sense multiple access with collision avoidance (CSMA-CA) scheme.

14. A server, comprising:
one or more memories;
one or more transceivers; and
one or more processors communicatively coupled to the one or more memories and the one or more transceivers, the one or more processors, either alone or in combination, configured to:
transmit, via the one or more transceivers, to one or more wireless relay nodes, first scheduling information indicating a first set of time slots allocated for transmission of alert packets by any wireless relay node;
receive, via the one or more transceivers, from a wireless relay node of the one or more wireless relay nodes, over at least one time slot of the first set of time slots, an alert packet indicating that a payload of a data packet transmitted by an energy harvesting tag includes critical information; and
transmit, via the one or more transceivers, to the one or more wireless relay nodes, second scheduling information indicating a second set of time slots allocated for transmission of alert packets by any wireless relay node, wherein the second set of time slots includes more time slots than the first set of time slots.

15. The server of claim 14, wherein:
the wireless relay node is a user equipment (UE); and
no time slots are allocated to one or more wireless radios associated with electronic label devices to transmit alert packets from energy harvest tags based on the one or more wireless radios being within a threshold distance of a location of the UE.

16. The server of claim 14, wherein the one or more processors, either alone or in combination, are further configured to:
transmit, via the one or more transceivers, to the wireless relay node, a request to provide payload information for the energy harvesting tag in a next relay transmission for the wireless relay node based on reception at the server of a threshold number of alert packets associated with the energy harvesting tag.

17. The server of claim 16, wherein the alert packet includes:
a description of the critical information;
header information from the data packet; or
a combination thereof.

18. The server of claim 14, wherein the one or more processors, either alone or in combination, are further configured to:
transmit, via the one or more transceivers, to one or more energizer devices, a request to increase transmission power to increase energizing coverage of the energy harvesting tag.

19. The server of claim 14, wherein the one or more processors, either alone or in combination, are further configured to:
transmit, via the one or more transceivers, to one or more energizer devices, a request to decrease a number of subframes for the energy harvesting tag to wait to transmit data packets.

20. The server of claim 14, wherein the one or more processors, either alone or in combination, are further configured to:
transmit, via the one or more transceivers, to one or more energizer devices, a location estimate of the energy harvesting tag.
